(19) United States
(12) Patent Application Publication
(10) Pub. No.: US 2017/0043460 A1
(43) Pub. Date: Feb. 16, 2017

(54) METHOD FOR A THREADED JOINT MOUNTING PROCESS

(71) Applicant: ATLAS COPCO INDUSTRIAL TECHNIQUE AB, Stockholm (SE)

(72) Inventor: Joakim Hans Ingemar GUSTAFSSON, Huddinge (SE)

(73) Assignee: ATLAS COPCO INDUSTRIAL TECHNIQUE AB, Stockholm (SE)

(21) Appl. No.: 15/118,955

(22) PCT Filed: Mar. 4, 2015
(86) PCT No.: PCT/EP2015/054455

§ 371 Date: Aug. 15, 2016

(30) Foreign Application Priority Data
Mar. 18, 2014 (SE) 1450297-5

(51) Int. Cl. B25B 23/147

(52) U.S. Cl. CPC B25B 23/147

(57) ABSTRACT

A method of obtaining high clamp force accuracy at a threaded joint mounting process by a power tool includes: registering, during a certain interval of the mounting process, tightening and loosening torques applied on the joint, rotational movement of an output shaft relative to a housing, and housing angular displacements about a rotation axis and in relation to an immobile point; calculating output shaft true rotational movements by comparing its rotational movements relative to the housing with the registered housing angular displacements; comparing the applied tightening and loosening torques during the certain interval to determine a clamp force related tightening torque; relating the determined tightening torque to the calculated output shaft rotational movements to determine a clamp force coefficient of the threaded joint; and completing the mounting process by tightening the joint to a target clamp force level by applying a determined clamp force coefficient based torque.

The invention relates to a method for obtaining a high clamp force accuracy at a threaded joint mounting process using a hand held power tool.

In particular the invention concerns an improved method for obtaining a high clamp force accuracy at tightening of a threaded joint by means of a hand held power tool by compensating the applied tightening torque for friction forces in the threaded joint.

### BACKGROUND

A well-known uncertainty factor in accomplishing a satisfactory clamp force accuracy in threaded joint mounting processes is the influence of the friction forces on the measured applied tightening torque, not only the friction forces per se but the variations in the friction coefficient. This makes a measured applied tightening torque non-consistent with a clamp force related torque, which results in an uncertainty and a scattering of the clamp force obtained by the joint.

In U.S. Pat. No. 5,571,971 there is described a method for dealing with the friction related problem by subtracting a loosening torque from a tightening torque applied to a threaded joint with the aim to compensate for the friction forces and thereby improve the accuracy as regard the clamp force generated by a measured applied tightening torque. This described method is disadvantageous in that it does not contain any measures for determining the true and accurate rotational movements of the threaded joint in relation to an immobile point, which means that the accuracy in determining the clamp force related torque will be rather poor. Calculation of the clamp force generating torque is very much dependent on an accurate determination of the angular positions of the threaded joint in relation to an immobile point during the process.

Accordingly, in a friction compensating method of the type described above you have to incorporate an accurate and reliable measurement of the angular movement of the threaded joint in relation to an immobile point. This becomes a real problem when threaded joints are tightened by means of a hand held torque delivering power tool, because in this type of tightening process the power tool housing is supported manually and the reaction torque exerted on the tool housing has to be counteracted by the operator, which means that there will inevitably occur some angular displacement of the power tool housing about the rotation axis of the output shaft of the tool and in relation to an immobile point. This means that the usually performed registration of the output shaft rotation relative to the tool housing will not represent the true output shaft angular movement relative to an immobile point. Accordingly, the registered tightening angle of the joint will be incorrect and will influence negatively on the accuracy of the friction compensating method described above.

### SHORT DESCRIPTION OF THE INVENTION

An object of the invention is to create a method for obtaining high clamp force accuracy during tightening of a threaded joint by means of a hand held power.

According to first aspect the invention relates to a method of obtaining a high clamp force accuracy during a threaded joint mounting process performed by means of a hand held torque delivering power tool including a housing, and a motor driven output shaft rotatably supported in the housing about a rotation axis. The method comprises the following steps:
registering during a certain interval of a threaded joint mounting process a tightening torque applied on the joint, the rotational movement of the output shaft relative to the housing, and occurring angular displacements of the housing about the rotation axis and in relation to an immobile point,
registering during a certain interval of a threaded joint mounting process a loosening torque applied on the joint, the rotational movement of the output shaft relative to the housing and, occurring angular displacements of the housing about the rotation axis and in relation to an immobile point,
calculating the true rotational movements of the output shaft relative to an immobile point by comparing the rotational movement of the output shaft relative to the housing with registered occurring angular displacements of the housing about the rotation axis and in relation to an immobile point,
comparing the applied tightening torque during said certain interval with the applied loosening torque during said certain interval to thereby determine the clamp force related tightening torque,
relating the determined clamp force related tightening torque to the calculated rotational movement of the output shaft relative to an immobile point to determine the clamp force coefficient of the threaded joint, and completing the threaded joint mounting process by tightening the threaded joint to a target clamp force level by applying a torque based on the determined clamp force coefficient.

The method according to the invention makes it possible to extend the use of hand held power tools also to the assembly of objects containing threaded joints considered critical for the assembly quality and/or safety. This extension of use of hand held power tools for tightening critical threaded joints also means an increased productivity in some applications where fixed tightening spindles were previously required.

In a specific embodiment of the invention occurring angular displacements of the housing in relation to an immobile point are registered via signals delivered by one or more gyro units attached to the housing.

In another specific embodiment occurring angular displacements of the housing in relation to an immobile point are registered via signals delivered by one or more accelerometer units attached to the housing.

Further advantages and characteristic features of the invention will appear from the following specification.

### SHORT DESCRIPTION OF THE DRAWINGS

A preferred embodiment of the invention is described in detail below with reference to the accompanying drawings.

FIG. 1 shows a diagram illustrating an initial phase of the threaded joint tightening method according to the invention.

FIG. 2 shows a diagram illustrating a second phase of the method according to the invention.

FIG. 3 shows a side view of a torque delivering power tool suitable for performing the method according to the invention.

FIG. 4 shows a top view of the power tool in FIG. 3.

### DETAILED DESCRIPTION OF THE INVENTION

The method according to the invention is based on a previously described method, like the one in U.S. Pat. No. 5,571,971, wherein an improved correlation is attempted to be obtained between the measured applied tightening torque and the obtained clamp force in a threaded joint. Basically the method comprises a sequence of threaded joint tightening and loosening movements of the joint wherein the applied torque is measured. The determined difference between the torque applied in the tightening direction T_{tight} and the torque applied in the loosening direction Tₗₒₒₛₑₙ gives information on the magnitude of the friction forces in the joint. This is illustrated by the following formulas:

T_{fight}=T_{friction}+T_{Clamp}

Tₗₒₒₛₑₙ=T_{friction}−T_{Clamp}

The resultant

T_{clamp}=½(T_{tight}−Tₗₒₒₛₑₙ)

As illustrated by the linear curve 1 in FIG. 1, the threaded joint is initially tightened by the application of a tightening torque up to a certain point 2 defined by an angular position φ2, thereby reaching a torque magnitude well below the supposed target torque level T_{T} in point 8. The applied torque is registered by a torque sensor in the power tool being used. Then a loosening torque is applied on the joint in point 4 resulting in a reverse rotation of the joint during a certain angular interval extending between φ₂ and φ₁, illustrated by numeral 3 in the diagram. As illustrated in FIG. 1 and the formulas above the loosening torque is substantially lower than the tightening torque depending on the fact that the clamp force installed in the joint will act in the loosening direction. The friction will be presumed to be the same during a loosening operation and tightening operation but directed opposed to the applied torque during both operations. As indicated in the formulas above the clamp generating torque T_{Clamp} will act to loosen the joint in both the loosening operation and tightening operation and will hence be added to the friction torque T_{friction} during a tightening operation, but subtracted from the friction torque T_{friction} during a loosening operation.

Hence, by measuring the difference between the tightening torque T_{tight} and the loosening torque Tₗₒₒₛₑₙ the magnitude of the clamp generating torque T_{Clamp} and the friction force T_{friction} may be calculated. Typically, the clamp generating torque T_{Clamp} is as low as about 10% of the friction related torque T_{friction}. To get redundant measurement of the friction force acting in the threaded joint a tightening torque may be reapplied on the joint in the angular position φ₁, illustrated by numeral 5. In the exemplary representation in FIG. 1 the linear torque growth during re-tightening between angular positions 5 and 6 takes place on a somewhat lower level than the initial tightening up to point 2. This may happen as result of a certain settling of the joint and in some cases due to a mechanical wear and smoothening of the friction generating surfaces during the first tightening and the following loosening. However, the difference between the upper tightening curve from φ₁ to φ₂ between points 1 and 2, and the lower loosening curve from φ₂ to φ₁, between points 4 and 3, represents two times the clamp force related torque, and an analysis of the re-tightening between angular positions 5 and 6 is not necessary for the assortment of the clamp force related torque.

By means of a bolt specific constant C_{Clamp} dependent of the physical properties of the threaded joint, such as diameter, and thread pitch the clamp force related torque T_{clamp} can be calculated within the angular interval φ₁−φ₂. The clamp force F_{clamp} is proportional to the clamp force related torque T_{clamp} according to the following relation:

F_{clamp}=C_{clamp}*T_{Clamp}

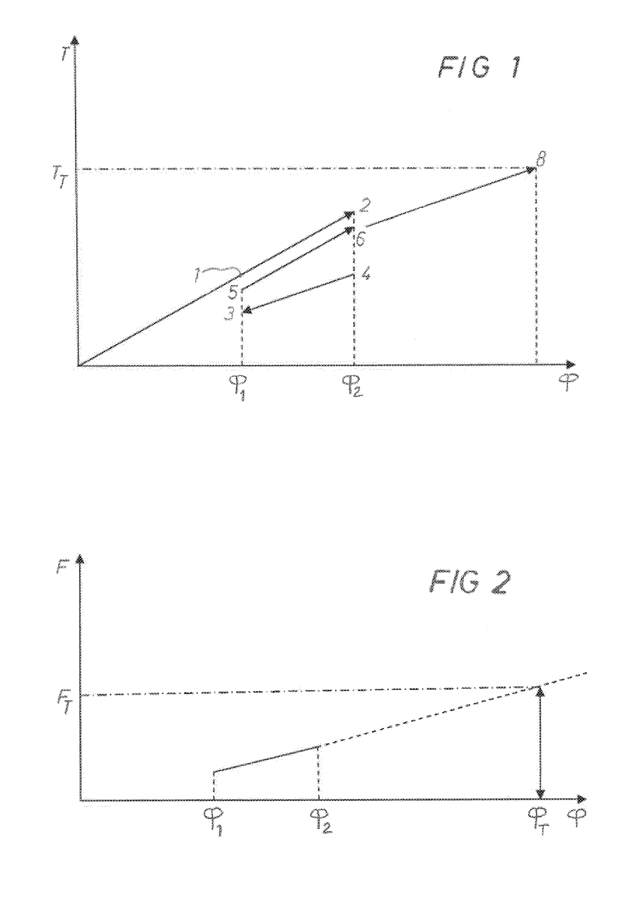

As illustrated in the diagram in FIG. 2 the growing clamp force F obtained during tightening and loosening operations between φ₁ and φ₂ is represented by a linear curve extending by a certain derivative, and by extrapolating this curve up to the desired clamp force target level F_{T} a target angular position φ_{T} corresponding to the clamp force target level F_{T} may be determined. The tightening operation may hence be performed to the specific target angular position φ_{T} instead of a target torque T_{T}.

It is important for the obtained accuracy of the angular position φ_{T} that the angular positions φ₁ and φ₂ are determined with great precision. As the method is intended to be used for hand held power tools the normal measurement of the rotational movement of the output shaft in relation to the tool housing is not enough, because the reaction torque exerted on the tool housing is manually counteracted it is not possible to foresee the angular displacement of the tool housing with respect to the rotation axis of the threaded joint. Therefore, in order to obtain an as accurate as possible registration of the lapsed rotation angle of the threaded joint during the tightening and loosening operations of this method occurring angular displacements of the tool housing in relation to an immobile point have to be measured and compensated for in the calculating process.

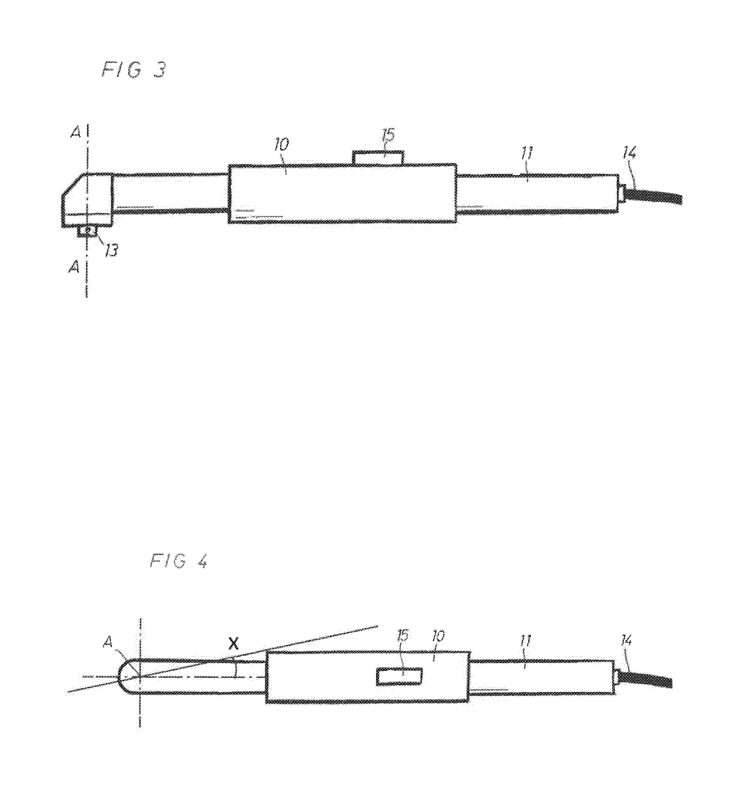

In FIG. 3 a hand held power tool adapted to perform the method according to the invention is illustrated. The tool comprises a housing 10 with a handle portion 11 for manual support of the tool and a motor driven output shaft 13 rotatable about a rotation axis A and arranged to be connected to a non-illustrated threaded joint to be tightened. The power tool further comprises both a torque meter to register the delivered output torque and an angle sensor for registering the rotational movement of the output shaft 13 relative to the tool housing 10. These devices are of a type common to this type of power tools and are not illustrated in detail. The power tool is connected to a power source via a cable 14.

In order to measure and register occurring angular displacements of the tool housing 10 about the rotation axis of the output shaft 13 and in relation to an immobile point there is employed a gyro unit 15 attached to the housing 10. By this gyro unit 15 it is possible to register any angular displacement X of the tool housing 10 about the rotation axis A of the output shaft 13 and in relation to an immobile point. The latter could be any fixed point adjacent the threaded joint or in the surrounding environment. The registered angular displacements of the tool housing 10 is calculated from the signals delivered by the gyro unit 15 and subtracted from the rotation angle registered by the angle sensor in the tool housing 10 to get the true lapsed angular movements of the threaded joint in relation to an immobile point.

A non-illustrated programmable calculating unit may be support on board the tool itself or be a separate unit connected to the tool via the cable 14 or any type of wireless communication.

It is to be understood that the invention is not limited to the described example but could be varied within the scope of the claims. For instance, the occurring angular displacements X of the tool housing during tightening operations could be measured and registered by other types of sensors like accelerometers perhaps in combination with gyro units.

1-3. (canceled)

4. A method of obtaining high clamp force accuracy at a threaded joint mounting process performed by a hand-held torque delivering power tool comprising a housing and a motor driven output shaft, the output shaft rotatably supported in the housing about a rotation axis (A), the method comprising:
registering, during a certain interval (φ₁−φ₂) of the threaded joint mounting process, a tightening torque applied on the joint, a rotational movement of the output shaft relative to the housing, and occurring angular displacements (X) of the housing about the rotation axis (A) and in relation to an immobile point;
registering, during the certain interval (φ₁−φ₂) of the threaded joint mounting process, a loosening torque applied on the joint, the rotational movement of the output shaft relative to the housing, and occurring angular displacements (X) of the housing about the rotation axis (A) and in relation to an immobile point;
calculating true rotational movement of the output shaft relative to an immobile point by comparing the rotational movement of the output shaft relative to the housing with registered occurring angular displacements (X) of the housing about the rotation axis (A) and in relation to an immobile point;
comparing the applied tightening torque during the certain interval (φ₁−φ₂) with the applied loosening torque during the certain interval (φ₁−φ₂) to thereby determine a clamp force related tightening torque;
relating the determined clamp force related tightening torque to the calculated rotational movement of the output shaft relative to an immobile point to determine a clamp force coefficient of the threaded joint; and
completing the threaded joint mounting process by tightening the threaded joint to a target clamp force level (F_{T}) by applying a torque based on the determined clamp force coefficient.

5. The method according to claim 4, wherein the occurring angular displacements (X) of the housing in relation to the immobile point are registered via signals delivered by at least one gyro unit attached to the housing.

6. The method according to claim 4, wherein the occurring angular displacements (X) of the housing in relation to the immobile point are registered via signals delivered by at least one accelerometer unit attached to the housing.

7. The method according to claim 5, wherein the occurring angular displacements (X) of the housing in relation to the immobile point are registered via signals delivered by at least one accelerometer unit attached to the housing.
